(19) United States
(12) Patent Application Publication
(10) Pub. No.: US 2002/0018582 A1
(43) Pub. Date: Feb. 14, 2002

(54) Control device and image processing device using same

(75) Inventors: Yasuji Hagiwara, Fukushima-ken (JP); Youtaro Sakakura, Fukushima-ken (JP); Kazuhito Ooshita, Fukushima-ken (JP); Isao Sato, Fukushima-ken (JP); Masahiro Soma, Fukushima-ken (JP); Hiroshi Nakahama, Fukushima-ken (JP)

Correspondence Address: Brinks Hofer Gilson & Lione, P.O. Box 10395, Chicago, IL, 60610, US

(73) Assignee: Alps Electric Co., Ltd

(21) Appl. No.: 09/922,336

(22) Filed: Aug. 3, 2001

(30) Foreign Application Priority Data
Aug. 11, 2000 (JP) 2000-243786
May 21, 2001 (JP) 2001-150337

(51) Int. Cl. G06K 9/00; G06K 9/36

(52) U.S. Cl. 382/107; 382/289

(57) ABSTRACT

Encoders as first detecting means detect rotations of a control body, and an acceleration sensor as second detecting means detects an acceleration applied to the control body. Based on the rotations and the acceleration, a ball displayed on a screen can be curved in the air. Consequently, an operator of a game can control the ball displayed on the screen or the like by controlling an impact, that is, an acceleration, a rotational direction, and a rotational speed.

### BACKGROUND OF THE INVENTION

1. Field of the Invention

The present invention relates to a control device used for game machines, and more particularly, to a control device improved in operability and availability for game machines and the like by detecting a rotation and an acceleration, as inputs, applied to a control body provided in the control device, and to an image processing device using the control device.

2. Description of the Related Art

Conventionally, control devices for game machines use a track ball. In the control devices, a spherical control body (track ball) is rotatably supported and, for example, pulse signals regarding the X- and Y-axis directions of a rotation applied to the control body are outputted to a game machine main body. In the game machine main body, a controller provided therein converts the outputs of the pulse signals into coordinate data, and outputs the converted data on to a screen of a TV monitor. The output data is displayed on the screen of the TV monitor as, for example, a motion of a ball.

In the case of being used in a football (soccer) game, the control body is assumed to be a soccer ball and, then, the control operation of the control body corresponds to, e.g., an operation for kicking the soccer ball by a character in the soccer game. The iterated rotations of the control body at short-time intervals causes the setting of a mode in which the character dribbles the soccer ball. The long-time rotation of the control body causes the setting of a long-ball mode in which the soccer ball is kicked very hard. Consequently, an operator can desirably control the soccer ball by various inputs to the control body.

The control body enables any control operation of the character and the soccer ball, thus enjoyably used in a variety of sport games.

In actual soccer plays, a frequently used technique is a so-called banana shot in that at the instant of kicking the soccer ball, a surface thereof is rubbed with the side of the shoe and, thereby, the kicked soccer ball is rotated and is curved in the air. In golf plays, used techniques are the so-called slice ball, hook ball, top spin, and back spin whereby at the instant of hitting a golf ball, a surface thereof is rubbed in various directions by a club face.

However, the conventional control devices are controlled by combining different means for inputting data such as the moving direction of the character, the soccer ball, or the golf ball, and an advancing direction and a flying direction of the kicked soccer ball or the hit golf ball, alternatively, by sequentially using single means for inputting the data.

In other words, in the conventional control devices, there is a problem in that it is impossible to simultaneously detect all of the rotations and accelerations and directions thereof which are applied when the operator controls the control body. By using the rotation and acceleration and the directions thereof which are simultaneously detected, the soccer ball or the golf ball cannot be controlled.

### SUMMARY OF THE INVENTION

To overcome the above-mentioned problem, it is an object of the present invention to provide a control device improved in operability and availability for game machines by simultaneously detecting a rotation and an acceleration and directions thereof, which are applied when an operator controls a control body, and an image processing device using the control device.

According to a first aspect of the present invention, a control device comprises: a frame; a control body which is rotatably provided on the frame; first detecting means for detecting a rotational direction and/or a rotational speed of the control body; and second detecting means for detecting an acceleration applied to the control body in at least one direction.

The control device further comprises: a supporting body for supporting the frame; and third detecting means provided on the supporting body, for detecting a moving direction and/or an amount of movement of the frame, wherein the first detecting means and the second detecting means are supported on the supporting body together with the frame in such a manner as to be movable in at least one direction perpendicular to a direction of the acceleration detected by the second detecting means.

The control device further comprises: a slider provided in the supporting body, for being moved in at least one direction perpendicular to the direction of the acceleration detected by the second detecting means, wherein the first detecting means is provided in the frame, the control body, the first detecting means, and the second detecting means are supported on the slider together with the frame, and the third detecting means detects a moving direction and/or an amount of movement of the slider.

The control device further comprises: a pair of the sliders provided in the supporting body, for being moved in directions perpendicular to each other on a plane perpendicular to the direction of the acceleration of the second detecting means, wherein the control body, the first detecting means, and the second detecting means can be moved together with the frame in directions on the plane in accordance with the movement of the pair of the sliders, and the third detecting means detects moving directions and/or amounts of movement of the pair of the sliders.

In the control device, the second detecting means is a piezoelectric-type or electrostatic-type acceleration sensor.

According to a second aspect of the present invention, a control device comprises: the control device having first detecting means and second detecting means; processing means for receiving detected signals from the first detecting means and the second detecting means in the control device; and display means having a screen, for displaying an image based on data processed by the processing means, wherein image processing is controlled by the data processing of the processing means so that an object displayed on the screen of the display means is controlled by the detected signals from the first detecting means and the second detecting means.

According to a third aspect of the present invention, the control device comprises: the control device having first detecting means, second detecting means, and third detecting means; processing means for receiving the detected signals from the first detecting means, the second detecting means, and the third detecting means in the control device; and display means having a screen, for displaying an image based on data processed by the processing means, wherein an image process is controlled based on the data process of the processing means so that an object displayed on the screen of the display means is controlled by the detected signals from the first detecting means, the second detecting means, and the third detecting means.

In the image processing device, in accordance with the detected signal from the first detecting means, the object is displayed and rotated.

In the image processing device, in accordance with the detected signal from the first detecting means, a moving direction of the object on the screen is determined.

In the image processing device, the image is processed so that, in accordance with the detected signal from the second detecting means, the moving direction of the object is determined or the object is moved with the acceleration.

In the image processing device, the image is processed so that: in accordance with the detected signal from the first detecting means, the object is displayed and rotated; in accordance with the detected signal from the second detecting means, the moving direction of the object is determined to be a first predetermined direction or the object is moved with the acceleration in a second predetermined direction; and in accordance with the detected signal from the third detecting means, the moving direction of the object is determined to be different from the first predetermined direction or the object is moved with the acceleration in a direction different from the second predetermined direction.

In the image processing device, the object is displayed to be moved by combining the detected signals from the first to third detecting means.

In the above control device of the present invention, only the control operation of the control body enables inputs of different data such as the rotation and acceleration applied to the control body and the moving directions thereof, thus controlling various application software.

Further, in the above control device of the present invention, also, by simultaneously detecting the rotation and the acceleration and the directions thereof which are applied to the control body, the operability of the control device is improved and the availability for the game and the like is also improved.

In the above image processing device using the image processing device of the present invention, based on the detected signal obtained by the control device, a motion of the character or the ball after applying an impact can be finely displayed on a screen. Consequently, for example, a banana shot becomes possible in a soccer game, and the golf ball can be controlled by using any desired technique of the operator such as a slice ball, a hook ball, or a back spin. Various games can be enjoyed with the realism in plays of soccer or golf.

Further, in the image processing device using the image processing device of the present invention, by combining the data, the character, the ball, etc. can be variously moved. Therefore, the operator can control the character, the ball, etc., thus improving the operability of the control device. Sport game software can further be executed with the realism.

In addition, in the image processing device using the control device of the present invention, the character or the ball displayed on the screen can be controlled in a three-dimensional coordinate system. Therefore, sport games can be enjoyed with the realism.

### BRIEF DESCRIPTION OF THE DRAWINGS

FIGS. 1A and 1B are diagrams showing a control device for a game machine or a personal computer according to a first embodiment of the present invention, in which

FIG. 1A is a front view of the control device and

FIG. 1B is a cross-sectional view of a line 1B in FIG. 1A;

FIG. 2 is a plan view schematically showing the internal structure of the control device shown in FIGS. 1A and 1B;

FIGS. 3A and 3B are diagrams showing a control device for a game machine or a personal computer according to a second embodiment of the present invention, in which

FIG. 3A is a cross-sectional view of the control device in the front direction thereof and

FIG. 3B is a plan view schematically showing the internal structure of the control device;

FIG. 4 is a perspective view of a frame and a control body in the control device shown in FIGS. 3A and 3B;

FIG. 5 is a diagram of the structure of a system of a game machine using the control device of the present invention;

FIG. 6 is an explanatory diagram showing one display example on a screen of display means;

FIG. 7 is an explanatory diagram showing another display example on the screen of the display means; and

FIG. 8 is an explanatory diagram showing another display example on the screen of the display means.

### DESCRIPTION OF THE PREFERRED EMBODIMENTS

Hereinbelow, embodiments of the present invention will be described with reference to the drawings.

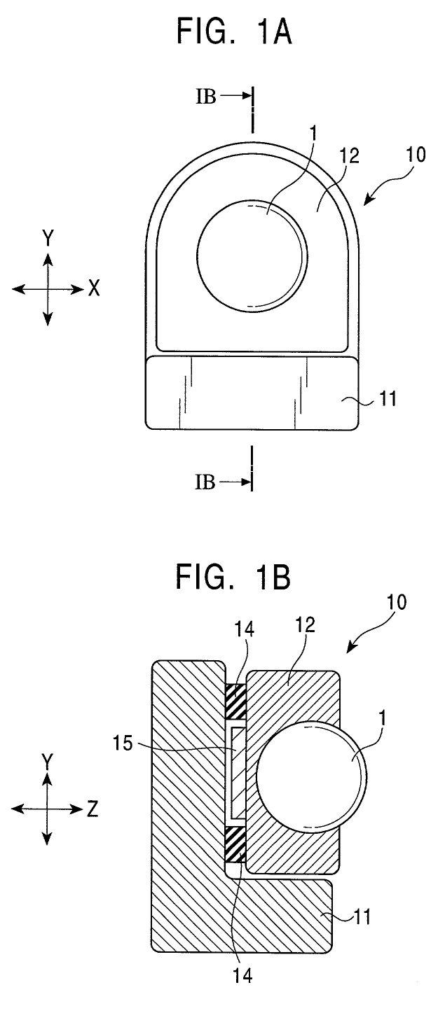

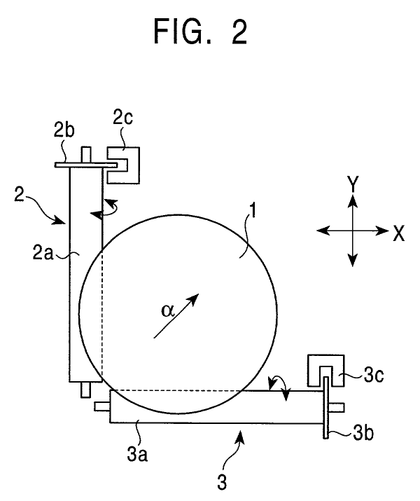

FIGS. 1A and 1B show a control device for a game machine or a personal computer according to a first embodiment of the present invention, in which FIG. 1A shows a front view of the control device and FIG. 1B shows a cross-sectional view of a line 1B in FIG. 1A, and FIG. 2 schematically shows a plan view of the internal structure of the control device in FIGS. 1A and 1B.

Referring to FIGS. 1A to 2, according to the first embodiment, in a control device 10, a spherical control body 1, a so-called track ball, is rotatably supported in a frame 12 in a three-dimensional direction. In the control device 10, a part of the control body 1 is exposed outside the frame 12. An operator can control the part of the control body 1 serving as the exposed portion.

The frame 12 is fixed to a supporting body 11 via elastic bodies 14, and is elastically supported to move in three-axis (X-, Y-, and Z-axis) directions. The elastic bodies 14 are made up of a highly elastic member such as a coil spring or a cushion member composed of rubber or resin, and can absorb an impact applied to the control body 1 in the three-axis directions.

First detecting means is an X-encoder 2 and a Y-encoder 3, which will be described later. An acceleration sensor 15 as second detecting means is fixed to the frame 12. The acceleration sensor 15 comprises a piezoelectric-type or electrostatic-type strain gauge and can detect an acceleration, which is applied to the control body 1, in at least one direction of the three-axis directions (e.g., X-axis directions). The acceleration sensor 15 may simultaneously detect the accelerations in two- or more-axis directions. The acceleration sensor 15 does not limit the motion of the control body 1 because of being fixed to the outside of the control body 1, instead of being directly mounted on the control body 1. As a consequence, in the control device 10, the decrease in operability of the control body 1 can be prevented. If the acceleration sensor 15 detects the accelerations in two- or more-axis directions, the strain gauge can be arranged independently in each axis direction, alternatively, the strain gauges for detecting the accelerations in the three-axis directions can be enclosed in one package.

As shown in FIG. 2, in the frame 12, the two encoders perpendicular to each other, as the first detecting means, are provided to come into contact with an external surface of the control body 1. One encoder is the X-encoder 2 having an axis in the X-direction and the other encoder is the Y-encoder 3 having an axis in the Y-direction. The axial directions of the X-encoder 2 and the Y-encoder 3 intersect at an angle of 90°.

The X-encoder 2 comprises a roller 2a which rotates around a central axis extending in the Y-axis direction and a disc 2b which rotates together with the roller 2a. Slit-shaped notches (not shown) are formed in the circumference of the disc 2b. The notches and non-notched portions (not shown) are alternately formed in the circumferential direction at predetermined pitches. A photocoupler 2c is provided in the circumference of the disc 2b. The photocoupler 2c comprises a light emitting element and a light receiving element which are opposed to each other. The circumference of the disc 2b lies between the light emitting element and the light receiving element. When the roller 2a and the disc 2b rotate, the notches and the non-notched portions pass through an interval between the light emitting element and the light receiving element. Then, a pulse signal, as a detected signal, is outputted from the photocoupler 2c in accordance with the rotational speeds of the roller 2a and the disc 2b.

The Y-encoder 3 comprises a roller 3a which rotates around a central axis extending in the X-axis direction, a disc 3b which rotates together with the roller 3a, and a photocoupler 3c opposed to the circumference of the disc 3b. In the circumference of the disc 3b, notches and non-notched portions (neither of which are shown in FIG. 2) are repeatedly formed in the circumferential direction at predetermined pitches. A pulse signal as a detected signal is outputted from the photocoupler 3c in accordance with the rotational speeds of the roller 3a and the disc 3b.

The control device 10 is controlled as follows when being connected to the game machine main body.

If the control body 1 rotates around a central axis extending in the Y-axis direction, the roller 2a and the disc 2b in the X-encoder 2 are rotated, thereby outputting, from the photocoupler 2c, the detected signal as a pulse signal in the X-axis direction. If the control body 1 rotates around a central axis extending in the X-axis direction, the roller 3a and the disc 3b in the Y-encoder 3 are rotated, thereby outputting, from the photocoupler 3c, the detected signal as a pulse signal in the Y-axis direction.

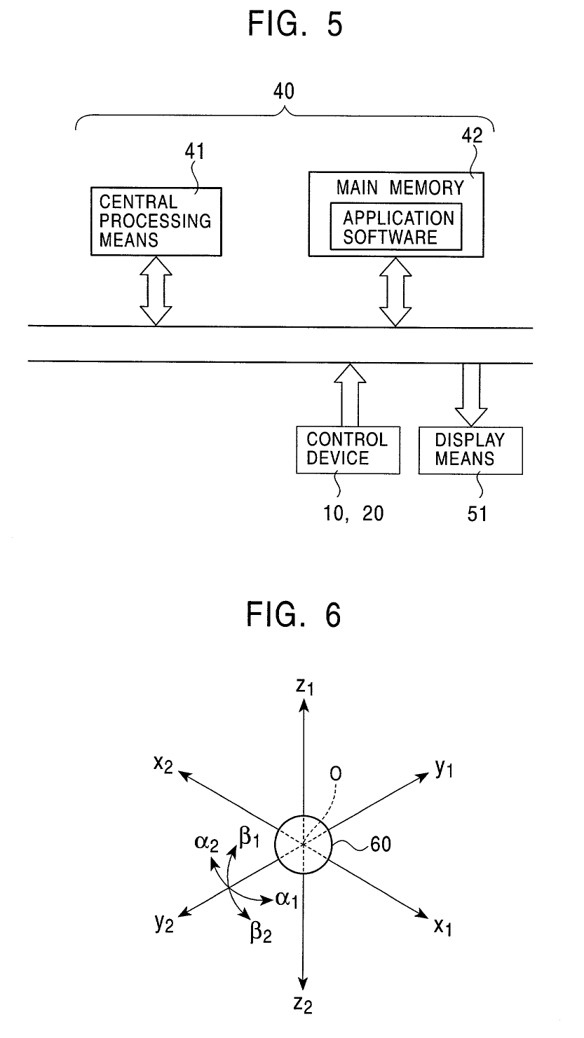

Referring to FIG. 5, the detected signals in the X- and Y-axis directions are transmitted to the game machine main body or a computer (not shown). In the central processing means (processing means) 41 of the game machine or the computer, the detected signal in the X-axis direction is converted into coordinate data in the X-axis direction via application software stored in a main memory 42, and the detected signal in the Y-axis direction is converted into coordinate data in the Y-axis direction. Based on the coordinate data, an image of an object such as a ball or a character is processed to rotate in the x-axis direction and/or y-axis direction on the screen of display means 51.

If the control body 1 is rotated, for example, in an α-direction with angles in the X-axis direction and the Y-axis direction (refer to FIG. 2), both the roller 2a and the roller 3a are rotated. Thus, the photocouplers 2c and 3c output the detected signals in the X-axis direction and in the Y-axis direction, the detected signals are converted into the coordinate data, and the image of the object is processed on the screen to rotate in the α-direction.

The acceleration sensor 15 detects the impact applied to the control body 1 in at least one-axis direction, and outputs the detected signal as an analog signal. A/D (analog/digital) converting means (not shown) provided in the control device 10 converts the analog signal into a digital signal of a predetermined number of bits, and outputs the converted signal to the central processing means 41 as the detected signal of the acceleration in at least one-axis direction.

The central processing means 41 receives the detected signal of the acceleration when the acceleration is applied to the control body 1. Based on the detected signal of the acceleration, a direction of the impact applied to the control body 1 (kicked direction), a strength of the impact (impact force), time, and the like are analyzed. Then, a moving direction and a speed of the soccer ball, etc. displayed on the screen are calculated as a vector, and the calculation is converted into the coordinate data. In other words, based on the detected signals, the game machine main body calculates an advancing direction and a speed of a display object (such as a ball) after applying the impact, and reflects the calculation as the motion of the object on the screen.

In the case of the soccer game, the soccer ball kicked in the air can become a banana shot, in which the ball is curved halfway, in accordance with the detected signals in the X- and Y-axis directions and the detected signal of the acceleration when the operator controls the control body 1. In the case of the golf game, the operator's control operation of the control body 1 is performed assuming that the golf ball is hit by a club face (at the moment of an impact). Based on the detected signals regarding the control body 1, the golf ball displayed on the screen can be hit as a slice ball, a hook ball, a back-spin ball, or a top-spin ball.

In the control device 10 shown in FIGS. 1A to 2, when the control body 1 is rotated, the ball or the character may be displayed on the screen to move in accordance with the rotational direction of the control body 1. Based on the signal detected by the acceleration sensor 15, the ball or the character may also be displayed on the screen to be controlled with the acceleration, for example, be bounced.

That is, the operator of the game machine finely controls a direction and an amount of control operation of the control body 1, thereby controlling the object on the screen. By using the data of the rotations in the X- and Y-axis directions in addition to the acceleration data when the control body 1 is controlled, a control device improved in operability and availability for many fields can be obtained. On the game software, by adding the detected signal of the acceleration, the capacity of the game is improved.

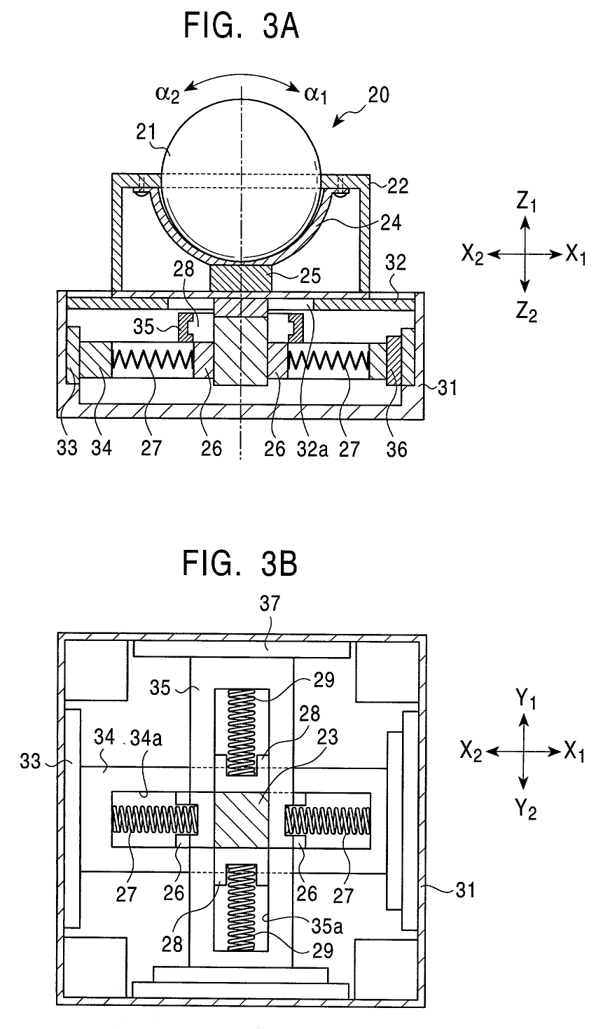

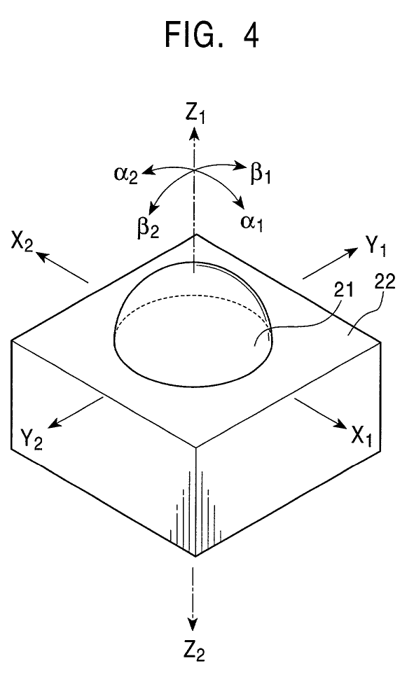

FIGS. 3A and 3B show a control device according to a second embodiment of the present invention, in which FIG. 3A shows a cross-sectional view of the control device in the front direction thereof and FIG. 3B schematically shows a plan view of the internal structure of the control device, and FIG. 4 shows a perspective view of a frame and a control body in the control device according to the second embodiment.

Referring to FIGS. 3A to 4, according to the second embodiment, in a control device 20, a frame 22 has the internal structure similar to that of the frame 12 in the first embodiment, and a ball-shaped control body (track ball) 21 is rotatably supported by the frame 22. Two X- and Y-encoders (not shown), as first detecting means, which are perpendicular to each other, are provided in the frame 22.

In the control device 20, when the control body 21 rotates, signals in the X-axis direction, detected by the X-encoder, correspond to a rotational direction and a rotational speed per unit time of the control body 21 which rotates around the X-axis, and signals in the Y-axis direction, detected by the Y-encoder, correspond to a rotational direction and a rotational speed per unit time of the control body 21 which rotates around the Y-axis.

In a supporting body 31 serving as a box-shaped case, a moving body 23 is movably provided along an XY-plane. In the frame 22, a hemispherical-shaped rotary supporting member 24 is provided to support the ball-shaped control body 21, an acceleration sensor 25 as second detecting means is provided between the moving body 23 and the rotary supporting member 24. Not only the frame 22 and the control body 21 but also the acceleration sensor 25 and the moving body 23 are integrally movable on the XY-plane.

The acceleration sensor 25 is a sensor for detecting a one-axis direction, which can detect the acceleration only in a Z₁Z₂-direction (shown in FIG. 3A) perpendicular to the XY-plane.

As shown in FIG. 3A, on the top of the supporting body 31, a casing member 32 for covering the supporting body 31 is provided. In the center of the casing member 32, an opening 32a is formed. The moving body 23, and the acceleration sensor 25 and the frame 22 which are provided thereon can be moved along the XY-plane within a range of the open area of the opening 32a.

In the supporting body 31, a first slide member 34 and a second slide member 35 are overlappingly provided in the Z-axis direction. Also, in the supporting body 31, a guide member 33 for guiding the first slide member 34 in the Y-axis direction and a linear sensor 36, opposed to the guide member 33, extending in the Y-axis direction are provided. Further, in the supporting body 31, a guide member 37 for guiding the second slide member 35 in the X-axis direction and a linear sensor 38, opposed to the guide member, extending in the X-axis direction are provided.

A guide length hole 34a shown in FIG. 3A, extending in the X-axis direction, is formed in the first slide member 34. In the first slide member 34, a pair of press members 26 is slidably provided. In the guide length holes 34a, compression coil springs 27 are provided for energizing the press members 26 in a direction to come into contact with each other. In the second slide member 35, a guide length hole 35a extending in the Y-axis direction is formed. In the guide length hole 35a, a pair of press members 28 is slidably provided and compression coil springs 29 are provided for energizing the press members 28 in a direction to come into contact with each other.

The moving body 23 is inserted into the guide length hole 34a of the first slide member 34 and into the guide length hole 35a of the second slide member 35. Further, the moving body 23 is located between the pair of press members 26 and a pair of press members 28 opposed thereto.

An energization force of the compression coil springs 27 and 29 causes the control body 21 or the frame 22 to be made stable in the center of the supporting body 31. When a force for movement is applied to the frame 22 on the XY-plane, in accordance with the movement, the first slide member 34 is moved in the Y-axis direction and the second slide member 35 is moved in the X-axis direction. The linear sensor 36 detects the direction and the amount of the movement of the first slide member 34 in the Y-axis direction. The linear sensor 38 detects the direction and the amount of the movement of the second slide member 35 in the X-axis direction.

The linear sensors 36 and 38 function as third detecting means, and comprise linear-change-type sensors of variable resonators, magnetic detectors, or optical detectors, etc.

In the control device 20, A/D converting means (not shown) is provided to convert, into digital signals of a predetermined number of bits, the detected signals from the two X- and Y-encoders (first detecting means) for detecting the rotational speed and the rotational direction of the control body 21 in X- and Y-axis directions, the detected signal from the acceleration sensor 25 (second detecting means), and the detected signals from the linear sensors 36 and 38 (third detecting means). The detected digital signals are supplied to central processing means 41 of a device main body 40 (shown in FIG. 5) of the game machine or the personal computer.

The detected digital signals are transmitted to the device main body 40 of the game machine or the personal computer via a cable line from the control device 20 or by a wireless manner using infrared light or radio waves.

Referring to FIG. 5, the device main body 40 has the central processing means 41 mainly composed of a CPU and a main memory 42. The detected signal from the control device 10 or 20 is transmitted to the central processing means 41 via a predetermined bus. Display means 51 having a screen is connected to the game machine or the personal computer. The display means 51 comprises a liquid crystal display device or a CRT device. In addition to the display means 51, an audio output unit such as a speaker is provided.

The main memory 42 stores application software. The device main body 40 comprises read means (not shown) for reading recording media such as a CD and a DVD, and receiving means (not shown) for data communication via a communication line such as the Internet. On the application software for the game machine, the recording media are read by the read means, and the read data is downloaded via the communication line and is stored in the main memory 42.

The central processing means 41 downloads the application software, and executes a process of contents thereof. This process corresponds to a display image process, an audio output process, and the like based on the detected signals from the control device 10 or 20.

A description is given of an operation for the image process when the control device 20 is controlled.

FIGS. 6 to 8 show display examples in which the object, e.g., the ball 60 is displayed on the screen of the display means 51. A space displayed on the screen is constructed by a virtual three-dimensional rectangular coordinate system (xyz-coordinate system), in which the x-axis shows an axis in the width direction on the screen, the y-axis shows an axis in the depth direction, the z-axis shows an axis in the height direction, a y₁-side shows the back side on the screen, and a y₂-side shows the front side on the screen. In the initial status of the control device 20, that is, when no input is supplied to the control device 20, a ball (object) 60 on the screen is set to the origin O of the virtual three-dimensional rectangular coordinate system (in other words, x=0, y=0, z=0). The setting of the origin O is varied depending on the type of game or the state during the game. In the case of hitting a golf ball in a golf game or of hitting a billiard ball on a plane in a billiard game, the origin O is set on a plane such as the ground in the image. In the case of directly hitting a ball in the air in a soccer game or a tennis game, the origin O is set in the air.

When the control body 21 is rotated, the central processing means 41 receives detected signals of the rotational speed per unit time and the rotational directions of the control body 21 in the X- and Y-axis directions, detected by the X- and Y-encoders having the structure similar to that of the first embodiment. When the control body 21 is hit down or the like, the detected signal from the acceleration sensor 25, as the acceleration information, is transmitted to the central processing means 41. Further, when the frame 22 is moved on the XY-plane, the detected signals from the linear sensors 36 and 38, as information on a moving direction and a moving speed of the frame 22, are transmitted to the central processing means 41.

Referring to FIG. 6, rotations of the ball 60 in an α₁- or α₂-direction and in a β₁- or β₂-direction on the screen correspond to the detected signals of rotations of the X- and Y-encoders, as the first detecting means, in the α₁-, or α₂-direction, and in the β₁- or β₂-direction.

An initial speed of the ball 60 on the screen in the case of starting the movement corresponds to the detected signal from the acceleration sensor 25 as the second detecting means. Further, a direction of the acceleration applied to the control body 21 corresponds to the detected signals from the linear sensors 36 and 38 as the third detecting means.

When the acceleration is applied to the control body 21 in a Z₂-direction and the frame 22 is at a point of intersection in the X- and Y-axes (origin on the XY-plane) as shown in FIG. 4, the image is processed on the screen so that the acceleration is applied to the ball 60 in the y₁-direction as shown in FIG. 6. When the acceleration is applied to the control body 21 in the Z₂-direction and the frame 22 is moved in an X₁- or X₂-direction as shown in FIG. 4, the image is processed on the screen so that the acceleration is applied to the ball 60 in an x₁- or x₂-direction as shown in FIG. 6.

When the acceleration is applied to the control body 21 in the Z₂-direction and the frame 22 is moved in a Y₁- or Y₂-direction as shown in FIG. 4, the image is processed on the screen so that the acceleration is applied to the ball 60 in the z₁- or z₂-direction as shown in FIG. 6. Thus, the operator controls the control body 21 while the frame 22 is universally moved in the X- and Y-axis directions and, thereby, the direction of the ball 60 on the start of the movement can be determined on the screen.

If the ball 60 after movement is affected by other external force such as gravity, air resistance, i.e., direction and strength of wind, frictional resistance when the ball 60 comes into contact with the ground or wall, or elastic force thereof, the image is processed on the screen so that the ball 60 is controlled under the above effects. In the case of the golf game, the image is processed on the screen so that the flying direction and the flying distance of the ball 60 are varied depending on the direction and strength of the wind. The image is processed on the screen so that the movement of the ball 60 is varied depending on a slope in the green of a golf course, grass grain of the green, and the like.

Hereinbelow, the image processing is further described in detail with reference to FIGS. 6 to 8.

If only the rotations detected by the X- and Y-encoders, as the first detecting means, in the α₁- or α₂-direction and in the β₁- or β₂-direction are applied to the control body 21 as shown in FIG. 4 and no outputs detected by the acceleration sensor 25 and the linear sensors 36 and 38, as the second and third detecting means, are applied to the control body 21, only the detected signals from the X- and Y-encoders are transmitted to the central control means 41. Referring to FIG. 6, in this case, on the virtual three-dimensional rectangular coordinate system on the screen, if the origin O is set in the air, the ball 60 is rotated in the α₁- or α₂-direction and in the β₁- or β₂-direction while being set to the origin O. Also, the image is displayed so that the ball 60 falls in the z₂-direction under the effect of gravity.

If the origin O is set to the ground and the rotation in the α₁- or α₂-direction is applied to the control body 21, the image is processed on the screen as shown in FIG. 6 so the ball 60 is rotated in the α₁- or α₂-direction at the origin O. If the rotation in the β₁- or β₂-direction is applied to the control body 21 while the ball 60 is placed on the ground, the image is processed on the screen as shown in FIG. 6 so that the ball 60 rotates in the y₁- or Y₂direction by friction between the ball 60 and the ground.

If the control body 21 is hit down in the Z₂-direction without rotation while the frame 22 is linearly moved in the X-axis direction (refer to FIG. 4), the control operation is as follows. That is, the central processing means 41 receives the detected signal from the acceleration sensor 25 as the second detecting means and the detected signals from the linear sensors 36 and 38 as the third detecting means. In accordance with the amount of movement of the frame 22 in the X-axis direction, the ball 60 on the screen is moved in the x-axis direction or in a direction of a combined vector in the x- and y-axis directions. On the other hand, if the control body 21 is hit down in the Z₂-direction with the rotation in the α₁- or α₂-direction while the frame 22 is linearly moved in the X-axis direction (refer to FIG. 4), the ball 60 on the screen is moved in the x-axis direction or in the direction of the combined vector in the x- and y-axis directions and, further, is curved in the right or left direction. Incidentally, the amount of curve of the ball 60 depends on the rotational speed of the control body 21 per unit time.

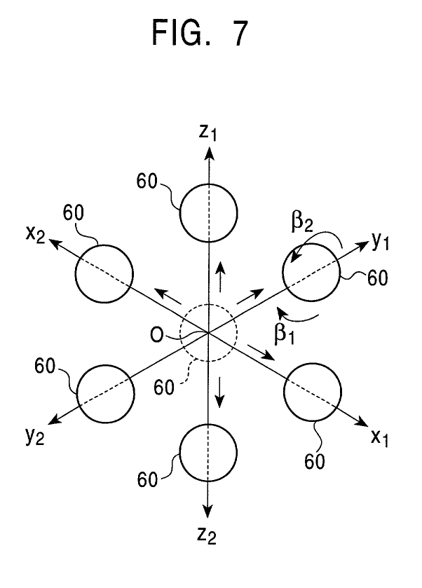

If the frame 22 is located at a point of intersection of the X-axis and the Y-axis and the control body 21 is hit down in the Z₂-direction without rotation (refer to FIG. 4), the central processing means 41 receives the detected signal from the acceleration sensor 25 as the second detecting means. In this case, if the initial ball 60 is placed on the ground in the image processing of the central processing means 41, the image is displayed on the screen as shown in FIG. 7 so that the ball 60 is moved in the y₁-direction.

If the frame 22 is moved to the back in the Y₁-direction and the control body 21 is hit down without rotation (refer to FIG. 4), the image is displayed on the screen as shown in FIG. 7 so that the ball 60 is moved in the z₁-direction.

If the frame 22 is moved to the back in the Y₁-direction, the control body 21 is hit down without rotation (refer to FIG. 4) and the initial ball 60 is set in the air, the image is displayed on the screen as shown in FIG. 7 so that the ball 60 is moved in the z₂-direction. Then, the ball 60 bounces against the ground and it is displayed on the screen as bouncing up in the z₁-direction by its elastic force. When the ball 60 reaches the top of the bounce under the influence of the gravity, the ball 60 falls down in the z₂-direction again. Further, the ball 60 repeatedly bounces against the ground. During the bouncing operation, the ball 60 is displayed on the screen so that the amount of bounce thereof is gradually attenuated.

If the X- and Y-encoders as the first detecting means, the acceleration sensor 25 as the second detecting means, and the linear sensors 36 and 38 as the third detecting means are simultaneously operated, the detected signals from the first to third detecting means are supplied to the central processing means 41. The central processing means 41 executes the image processing based on information obtained by combining the detected signals.

Referring back to FIG. 4, when the frame 22 is set at the origin on the XY-plane and the control body 21 is rotated in the β₁-direction and is accelerated in the Z₂-direction, the central processing means 41 receives the rotational information from the X- and Y-encoders as the first detecting means, the acceleration information from the acceleration sensor 25 as the second detecting means, and the movement information from the linear sensors 36 and 38 as the third detecting means. In this case, if the origin O is set to the ground as the initial state of the ball 60, the ball 60 in FIG. 7 fast rotates in the y₁-direction from the origin O while being rotated in the β₁-direction.

If the frame 22 is set to a point of intersection of the X-axis and the Y-axis, that is, the origin on the XY-plane and the control body 21 is rotated and accelerated in the β₂-direction as shown in FIG. 4, the ball 60 in FIG. 7 is temporarily moved in the y₁-direction on the screen. After that, the image is displayed on the screen as shown in FIG. 7 so that the ball 60 is returned in the y₂-direction and rotated in the β₂-direction by backspin.

As shown in FIG. 7, the ball 60 can be displayed on the screen to be rotated and bounced in the y₁-direction or to be bounced and returned in the y₂-direction by a backspin, depending on the environment of the application software.

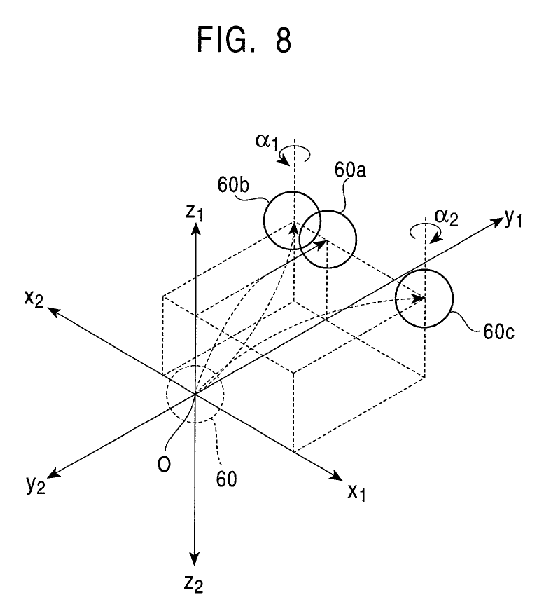

The display operation is varied depending on the combination of the detected signals of the first to third detecting means. Referring to FIG. 8, for example, if a pressure in the middle direction between the X₁-direction and Y₁-direction is applied to the frame 22 and the acceleration in the Z₂-direction is applied to the control body 21 as shown in FIG. 4, the ball 60 on the screen jumps on a y₁z₁-plane from the origin O with an angle corresponding to the pressure applied to the frame 22 in the middle direction between the X₁-direction and Y₁-direction (refer to reference numeral 60a in FIG. 8). Simultaneously, when the control body 21 is rotated in the α₁-direction as shown in FIG. 4, the image is processed so that the ball 60 on the screen is curved in the left direction in an x₁y₁z₁-space (refer to reference numeral 60b in FIG. 8). If the ball 60 on the screen is rotated in the α₂-direction as shown in FIG. 4, the image is processed so that the ball 60 is right curved in a direction in an x₂y₁z₁-space (refer to reference numeral 60c in FIG. 8). The amount of curve of the ball 60 is varied depending on the rotational speed thereof and the direction and the strength of the wind. The locus of the ball 60 is parabolic and, after the ball 60 reaches the vertex, it approaches an x₁x₂-plane under the effect of gravity. The above control operation is image-processed. Consequently, in the soccer game, the banana shot can be expressed on the screen and in the case of the golf game, a hook ball or a slice ball using a driver or an iron golf club can also be expressed on the screen.

In other words, the object displayed based on the detected signal from the first detecting means may be rotated on the screen in accordance with the rotational direction of the control body 21 and, alternatively, the above object may be moved on the screen in accordance with the rotational direction of the control body 21. Also, by using the detected signal from the second detecting means, the moving direction of the object displayed on the screen may be determined, the direction of the speed or acceleration of the object on the screen may be determined, or, the object may be controlled on the screen with the acceleration in the case of bounce. Further, by using the detected signals from the third detecting means, the direction of the movement, the speed, and the acceleration of the object may be set to be different from those from the second detecting means. Furthermore, the object may be controlled with the acceleration in the X- and Y-axis directions by the third detecting means.

As described above, by detection using the combination of the detected signals from the three detecting means, the various images can be displayed on the screen in accordance with the application software.

Accordingly, a character can be variably controlled on the screen.

What is claimed is:

1. A control device comprising:
a frame;
a control body which is rotatably provided on said frame;
first detecting means for detecting a rotational direction and/or a rotational speed of said control body; and
second detecting means for detecting an acceleration applied to said control body in at least one direction.

2. A device according to claim 1, further comprising:
a supporting body for supporting said frame; and
third detecting means provided on said supporting body, for detecting a moving direction and/or an amount of movement of said frame,
wherein said first detecting means and said second detecting means are supported on said supporting body, together with said frame in such a manner as to be movable in at least one direction perpendicular to a direction of the acceleration detected by said second detecting means.

3. A device according to claim 2, further comprising:
a slider provided in said supporting body, for being moved in at least one direction perpendicular to the direction of the acceleration detected by said second detecting means,
wherein said first detecting means is provided in said frame,
said control body, said first detecting means, and said second detecting means are supported by said slider together with said frame, and
said third detecting means detects a moving direction and/or an amount of movement of said slider.

4. A device according to claim 3, further comprising:
a pair of said sliders provided in said supporting body, for being moved in directions perpendicular to each other on a plane perpendicular to the direction of the acceleration of said second detecting means,
wherein said control body, said first detecting means, and said second detecting means can be moved together with said frame in directions on said plane in accordance with the movement of said pair of said sliders, and
said third detecting means detects moving directions and/or amounts of movement of said pair of said sliders.

5. A device according to claim 1, wherein said second detecting means is a piezoelectric-type or electrostatic-type acceleration sensor.

6. An image processing device comprising:
a control device according to claim 1, wherein said control device comprises said first detecting means and second detecting means;
processing means for receiving detected signals from said first detecting means and said second detecting means; and
display means having a screen, for displaying an image based on data processed by said processing means,
wherein image processing is controlled by the data processing of said processing means so that an object displayed on the screen of said display means is controlled by the detected signals from said first detecting means and said second detecting means.

7. An image processing device, comprising:
a control device according to claim 2, wherein said control device comprises said first detecting means, second detecting means, and said third detecting means;
processing means for receiving the detected signals from said first detecting means, said second detecting means, and said third detecting means; and
display means having a screen, for displaying an image based on data processed by said processing means,
wherein image processing is controlled based on the data processing of said processing means so that an object displayed on the screen of said display means is controlled by the detected signals from said first detecting means, said second detecting means, and said third detecting means.

8. A device according to claim 6, wherein, in accordance with the detected signal from said first detecting means, said object is displayed and rotated.

9. A device according to claim 6, wherein, in accordance with the detected signal from said first detecting means, a moving direction of said object on the screen is determined.

10. A device according to claim 6, wherein the image is processed so that, in accordance with the detected signal from said second detecting means, the moving direction of said object is determined or said object is moved with the acceleration.

11. A device according to claim 7, wherein the image is processed so that:
in accordance with the detected signal from said first detecting means, said object is displayed and rotated;
in accordance with the detected signal from said second detecting means, the moving direction of said object is determined to be a first predetermined direction or said object is moved with the acceleration in a second predetermined direction; and
in accordance with the detected signal from said third detecting means, the moving direction of said object is determined to be different from said first predetermined direction or said object is moved with the acceleration in a direction different from said second predetermined direction.

12. A device according to claim 6, wherein said object is displayed to be moved by combining the detected signals from said first to third detecting means.
